(19) United States
(12) Patent Application Publication
(10) Pub. No.: US 2018/0176893 A1
(43) Pub. Date: Jun. 21, 2018

(54) METHOD, DEVICE, AND USER EQUIPMENT FOR RECEIVING DOWNLINK INFORMATION

(71) Applicant: ZTE CORPORATION, Shenzhen, Guangdong (CN)

(72) Inventors: Wen ZHANG, Shenzhen, Guangdong (CN); Shuqiang XIA, Shenzhen, Guangdong (CN); Bo DAI, Shenzhen, Guangdong (CN); Jing SHI, Shenzhen, Guangdong (CN); Kun LIU, Shenzhen, Guangdong (CN); Xianming CHEN, Shenzhen, Guangdong (CN); Huiying FANG, Shenzhen, Guangdong (CN)

(21) Appl. No.: 15/565,478

(22) PCT Filed: Feb. 29, 2016
(86) PCT No.: PCT/CN2016/074856

§ 371 Date: Oct. 10, 2017

(30) Foreign Application Priority Data
Apr. 10, 2015 (CN) 201510170228.X

(51) Int. Cl. H04W 72/04; H04W 4/06; H04W 68/02; H04W 74/08

(52) U.S. Cl. CPC H04W 72/042; H04W 4/06; H04L 12/189; H04W 74/0833; H04W 68/02

(57) ABSTRACT

Provided are a method, device and user equipment for receiving downlink information. The method includes: determining downlink information to be preferentially received according to at least one of: UE state, subframe type of a subframe for transmitting downlink information, and information type of downlink information; and receiving the downlink information.

### TECHNICAL FIELD

The present disclosure relates to the field of communications and, in particular, to a method, device and user equipment for receiving downlink information.

### BACKGROUND

Machine Type Communication (MTC) user equipment (UE), also referred to as Machine to Machine (M2M) user communication equipment, is currently the primary application mode of the Internet of Things.

In recent years, more and more mobile operators have chosen Long-Term Evolution Advance (LTE/LTE-A) as the evolution direction of the broadband wireless communication system due to the high spectral efficiency of LTE/LTE-A. Various MTC data services based on LTE/LTE-A will also be more attractive.

MTC equipment is usually low-cost and featured by a small Radio Frequency (RF) bandwidth and a single receiving antenna. A type of MTC equipment such as an electricity meter may be placed in a metal cabinet in a basement and thus be poorly covered. In the related art, solutions for enhancing coverage improve coverage by a large number of repetitions of certain channels.

However, since an MTC UE has a small receiving bandwidth, the UE can only choose to receive information on one narrowband if multiple pieces of information, such as a Random Access Response (RAR), a paging message, a system message, downlink data, etc., are sent on different narrowbands of one subframe. In the case of coverage enhancement, a system may be inefficient if the UE makes an improper choice.

No efficient solution has been provided to solve the low efficiency when the UE receives multiple pieces of downlink information on one narrowband in the related art.

### SUMMARY

To solve the above problem, embodiments of the present disclosure provide a method, device and user equipment for receiving downlink information.

According to one embodiment of the present disclosure, provided is a method for receiving downlink information. The method includes: determining downlink information to be preferentially received according to at least one of: UE state, subframe type of a subframe for transmitting downlink information, and information type of downlink information; and receiving the downlink information.

Preferably, the UE state includes at least one of: during a random access procedure, in a radio resource control (RRC) idle state, in an RRC connected state, in a system message change period and in a Multicast Control Channel (MCCH) change period.

Preferably, the subframe type includes: Multimedia Broadcast Multicast Service Single Frequency Network (MBSFN) subframe or non-MBSFN subframe.

Preferably, the information type includes at least two of: downlink control channel for scheduling an RAR and/or the RAR; downlink control channel for scheduling a message 4 during the random access procedure and/or the message 4; downlink control channel for scheduling a paging message and/or the paging message; downlink control channel for scheduling a system message and/or the system message; downlink control channel for scheduling the UE to send a Physical Uplink Shared Channel (PUSCH); downlink control channel for scheduling the UE to send a Physical Downlink Shared Channel (PDSCH) and/or the PDSCH of the UE; PDSCH for Semi-Persistent Scheduling (SPS); downlink control channel for scheduling a retransmitted PDSCH and/or retransmitted PDSCH; MCCH change notification information; and Physical Multicast Channel (PMCH).

Preferably, the downlink control channel includes one of: Physical Downlink Control Channel (PDCCH) and Enhanced Physical Downlink Control Channel (EPDCCH).

Preferably, the MCCH change notification information and the PMCH further include at least one of the following cases: the MCCH change notification information and/or information of a narrowband where the PMCH locates are/is notified by an eNB in a system information block (SIB) or an MCCH; information of a narrowband where the MCCH locates is notified by the eNB in the SIB; and information of a narrowband carrying a Multimedia Broadcast Multicast Service (MBMS) in the PMCH is notified by the eNB in the SIB or the MCCH.

Preferably, the method further includes: notifying, by a Multicell/Multicast Coordination Entity (MCE), the eNB of the MCCH change notification information and/or the information of a narrowband where the PMCH and/or the MCCH locates and/or the information of a narrowband carrying the MBMS in the PMCH.

Preferably, receiving the downlink information includes: preferentially detecting a downlink control channel for scheduling an RAR and/or receiving the RAR when a UE is in an RAR time window during a random access procedure and before the UE receives the RAR.

Preferably, receiving the downlink information includes: preferentially detecting a downlink control channel for scheduling a message 4 and/or receiving the message 4 when a UE is in a subframe for detecting the downlink control channel for scheduling the message 4 and/or receiving the message 4 during a random access procedure.

Preferably, receiving the downlink information includes: preferentially detecting a downlink control channel for scheduling a paging message and/or receiving the paging message when a UE is in an RRC idle state and in a subframe for detecting the downlink control channel for scheduling the paging message and/or receiving the paging message, where the subframe for detecting the downlink control channel for scheduling the paging message and/or receiving the paging message includes: MBSFN subframe or non-MBSFN subframe.

Preferably, receiving the downlink information includes: preferentially detecting a downlink control channel for scheduling a paging message and/or receiving the paging message when a UE is in an RRC connected state, in a system message change period and in a designated subframe for detecting the downlink control channel for scheduling the paging message and/or receiving the paging message, where the designated subframe for detecting the downlink control channel for scheduling the paging message and/or receiving the paging message includes: MBSFN subframe or non-MBSFN subframe.

Preferably, the designated subframe for detecting the downlink control channel for scheduling the paging message and/or receiving the paging message includes: a first preset subframe in the system message change period, and a subframe for detecting the downlink control channel for scheduling the paging message and/or receiving the paging message after the first preset subframe and before the paging message is received.

Preferably, the first preset subframe includes one of the following features: a number of subframes between a starting subframe of the system message change period and the first preset subframe is a preset value; a number of subframes between the first preset subframe and an ending subframe of the system message change period is a preset value; a number of opportunities for receiving the paging message between the starting subframe of the system message change period and the first preset subframe is a preset value; and a number of opportunities for receiving the paging message between the first preset subframe and the ending subframe of the system message change period is a preset value.

Preferably, receiving the downlink information includes: preferentially detecting a downlink control channel for scheduling a system message and/or receiving the system message in a system message change period after a UE receives a system message change notification and in a subframe for detecting the downlink control channel for scheduling the system message and/or receiving the system message before the UE correctly receives the system message, where the subframe for detecting the downlink control channel for scheduling the system message and/or receiving the system message includes: MBSFN subframe or non-MBSFN subframe.

Preferably, receiving the downlink information includes: preferentially detecting a downlink control channel for scheduling a system message and/or receiving the system message in a preset time when a UE does not receive a system message change notification and in a subframe for detecting the downlink control channel for scheduling the system message and/or receiving the system message before the UE correctly receives the system message, where the subframe for detecting the downlink control channel for scheduling the system message and/or receiving the system message includes: MBSFN subframe or non-MBSFN subframe.

Preferably, receiving the downlink information includes: preferentially receiving a PDSCH in an overlapping subframe when a time window in which a UE receives the PDSCH overlaps a designated time window and when an initial position of the time window in which the UE receives the PDSCH is earlier than or equal to an initial position of the designated time window; or preferentially receiving a PDSCH in an overlapping subframe when a time window in which a UE detects a downlink control channel for scheduling a retransmitted PDSCH and/or receives the retransmitted PDSCH overlaps a designated time window and when an initial position of the time window in which the UE detects the downlink control channel for scheduling the retransmitted PDSCH and/or receives the retransmitted PDSCH is earlier than or equal to an initial position of the designated time window.

Preferably, the designated time window includes one of: RAR time window in which the UE receives an RAR; time window in which the UE detects a downlink control channel for scheduling a paging message and/or receives the paging message; time window in which the UE detects a downlink control channel for scheduling a system message and/or receives the system message; time window in which the UE receives a PMCH; and time window in which the UE detects an MCCH change notification information.

Preferably, receiving the downlink information includes: preferentially receiving a PMCH in a designated MBSFN subframe when a UE supports an MBMS.

Preferably, receiving the downlink information includes: preferentially detecting an MCCH change notification information in a designated MBSFN subframe in an MCCH change period.

Preferably, the designated MBSFN subframe includes: a second preset subframe in the MCCH change period, and a subframe for receiving the MCCH change notification information after the second preset subframe and before the UE detects the MCCH change notification.

Preferably, the second preset subframe includes one of the following features: a number of subframes between a starting subframe of the MCCH change period and the second preset subframe is a preset value; a number of subframes between the second preset subframe and an ending subframe of the MCCH change period is a preset value; a number of opportunities for receiving the MCCH change notification information between the starting subframe of the MCCH change period and the second preset subframe is a preset value; and a number of opportunities for receiving the MCCH change notification information between the second preset subframe and the ending subframe of the MCCH change period is a preset value.

According to another embodiment of the present disclosure, provided is a device for receiving downlink information. The device includes: a determining module, which is configured to determine downlink information to be preferentially received according to at least one of: UE state, subframe type of a subframe for transmitting downlink information, and information type of downlink information; and a receiving module, which is configured to receive the downlink information.

Preferably, the UE state includes at least one of: during a random access procedure, in an RRC idle state, in an RRC connected state, in a system message change period and in an MCCH change period.

Preferably, the subframe type includes: MBSFN subframe or non-MBSFN subframe.

Preferably, the information type includes at least two of: downlink control channel for scheduling an RAR and/or RAR; downlink control channel for scheduling a message 4 during the random access procedure and/or message 4; downlink control channel for scheduling a paging message and/or paging message; downlink control channel for scheduling a system message and/or system message; downlink control channel for scheduling the UE to send a PUSCH; downlink control channel for scheduling the UE to send a PDSCH and/or PDSCH of the UE; PDSCH for SPS; downlink control channel for scheduling a retransmitted PDSCH and/or retransmitted PDSCH; MCCH change notification information; and PMCH.

Preferably, the downlink control channel includes one of: PDCCH and EPDCCH.

Preferably, the MCCH change notification information and the PMCH further include at least one of the following cases: the MCCH change notification information and/or information of a narrowband where the PMCH locates are/is notified by an eNB in a SIB or an MCCH; information of a narrowband where the MCCH locates is notified by the eNB in the SIB; and information of a narrowband carrying an MBMS in the PMCH is notified by the eNB in the SIB or the MCCH.

Preferably, the receiving module is configured to preferentially detect a downlink control channel for scheduling an RAR and/or receive the RAR when a UE is in an RAR time window during a random access procedure and before the UE receives the RAR.

Preferably, the receiving module is configured to preferentially detect a downlink control channel for scheduling a message 4 and/or receive the message 4 when a UE is in a subframe for detecting the downlink control channel for scheduling the message 4 and/or receiving the message 4 during a random access procedure.

Preferably, the receiving module is configured to preferentially detect a downlink control channel for scheduling a paging message and/or receive the paging message when a UE is in an RRC idle state and in a subframe for detecting the downlink control channel for scheduling the paging message and/or receiving the paging message, where the subframe for detecting the downlink control channel for scheduling the paging message and/or receiving the paging message includes: MBSFN subframe or non-MBSFN subframe.

Preferably, the receiving module is configured to preferentially detect a downlink control channel for scheduling a paging message and/or receive the paging message when a UE is in an RRC connected state, in a system message change period and in a designated subframe for detecting the downlink control channel for scheduling the paging message and/or receiving the paging message, where the designated subframe for detecting the downlink control channel for scheduling the paging message and/or receiving the paging message includes: MBSFN subframe or non-MBSFN subframe.

Preferably, the designated subframe for detecting the downlink control channel for scheduling the paging message and/or receiving the paging message includes: a first preset subframe in the system message change period, and a subframe for detecting the downlink control channel for scheduling the paging message and/or receiving the paging message after the first preset subframe and before the paging message is received.

Preferably, the first preset subframe includes one of the following features: a number of subframes between a starting subframe of the system message change period and the first preset subframe is a preset value; a number of subframes between the first preset subframe and an ending subframe of the system message change period is a preset value; a number of opportunities for receiving the paging message between the starting subframe of the system message change period and the first preset subframe is a preset value; and a number of opportunities for receiving the paging message between the first preset subframe and the ending subframe of the system message change period is a preset value.

Preferably, the receiving module is configured to preferentially detect a downlink control channel for scheduling a system message and/or receive the system message in a system message change period after a UE receives a system message change notification and in a subframe for detecting the downlink control channel for scheduling the system message and/or receiving the system message before the UE correctly receives the system message, where the subframe for detecting the downlink control channel for scheduling the system message and/or receiving the system message includes: MBSFN subframe or non-MBSFN subframe.

Preferably, the receiving module is configured to preferentially detect a downlink control channel for scheduling a system message and/or receive the system message in a preset time when a UE does not receive a system message change notification and in a subframe for detecting the downlink control channel for scheduling the system message and/or receiving the system message before the UE correctly receives the system message, where the subframe for detecting the downlink control channel for scheduling the system message and/or receiving the system message includes: MBSFN subframe or non-MBSFN subframe.

Preferably, the receiving module is configured to preferentially receive a PDSCH in an overlapping subframe when a time window in which a UE receives the PDSCH overlaps a designated time window and when an initial position of the time window in which the UE receives the PDSCH is earlier than or equal to an initial position of the designated time window; or preferentially receive a PDSCH in an overlapping subframe when a time window in which a UE detects a downlink control channel for scheduling a retransmitted PDSCH and/or receives the retransmitted PDSCH overlaps a designated time window and when an initial position of the time window in which the UE detects the downlink control channel for scheduling the retransmitted PDSCH and/or receives the retransmitted PDSCH is earlier than or equal to an initial position of the designated time window.

Preferably, the designated time window includes one of: RAR time window in which the UE receives an RAR; time window in which the UE detects a downlink control channel for scheduling a paging message and/or receives the paging message; time window in which the UE detects a downlink control channel for scheduling a system message and/or receives the system message; time window in which the UE receives a PMCH; and time window in which the UE detects an MCCH change notification information.

Preferably, the receiving module is configured to preferentially receive a PMCH in a designated MBSFN subframe when a UE supports an MBMS.

Preferably, the receiving module is configured to preferentially detect an MCCH change notification information in a designated MBSFN subframe in an MCCH change period.

Preferably, the designated MBSFN subframe includes: a second preset subframe in the MCCH change period, and a subframe for receiving the MCCH change notification information after the second preset subframe and before the UE detects the MCCH change notification.

Preferably, the second preset subframe includes one of the following features: a number of subframes between a starting subframe of the MCCH change period and the second preset subframe is a preset value; a number of subframes between the second preset subframe and an ending subframe of the MCCH change period is a preset value; a number of opportunities for receiving the MCCH change notification information between the starting subframe of the MCCH change period and the second preset subframe is a preset value; and a number of opportunities for receiving the MCCH change notification information between the second preset subframe and the ending subframe of the MCCH change period is a preset value.

According to another embodiment of the present disclosure, provided is a UE, including the above device for receiving downlink information.

According to embodiments of the present disclosure, the downlink information to be preferentially received is determined according to at least one of: UE state, subframe type of a subframe for transmitting downlink information, and information type of downlink information; and the downlink information is then received. This solves the low efficiency problem when the UE receives multiple pieces of downlink information on one narrowband, and thus improves the efficiency of the UE in receiving downlink information.

### BRIEF DESCRIPTION OF DRAWINGS

The accompanying drawings described herein are used to provide a further understanding of the present disclosure, and form a part of the present application. The schematic embodiments and descriptions thereof of the present disclosure are used to explain the present disclosure, and do not form improper limits to the present disclosure. In the accompanying drawings:

FIG. 1 is a flowchart of a method for receiving downlink information according to an embodiment of the present disclosure;

FIG. 2 is a schematic structural diagram of a device for receiving downlink information according to an embodiment of the present disclosure;

FIG. 3 is a schematic structural diagram of a paging subframe according to a preferred embodiment of the present disclosure;

FIG. 4 is another schematic structural diagram of a paging subframe according to a preferred embodiment of the present disclosure;

FIG. 5 is yet another schematic structural diagram of a paging subframe according to a preferred embodiment of the present disclosure;

FIG. 6 is a schematic structural diagram of a time window according to a preferred embodiment of the present disclosure; and

FIG. 7 is another schematic structural diagram of a time window according to a preferred embodiment of the present disclosure.

### DETAILED DESCRIPTION

The present disclosure will be described hereinafter in detail with reference to the accompanying drawings in connection with the embodiments. It is to be noted that if not conflicted, the embodiments and features therein in the present application may be combined with each other.

Other features and advantages of the present disclosure will be elaborated hereinafter in the specification, and moreover, partially become apparent from the specification, or will be understood through implementation of the present disclosure. The object and other advantages of the present disclosure may be achieved and obtained through structures set forth in the specification, claims and drawings.

Solutions in embodiments of the present disclosure will be described clearly and completely in connection with the accompanying drawings in embodiments of the present disclosure from which the solutions will be apparent to those skilled in the art. The embodiments described below are part, not all, of embodiments of the present disclosure. On the basis of the embodiments in the present disclosure, other embodiments obtained by those skilled in the art without creative work are in the scope of the present disclosure.

According to the solutions provided by embodiments of the present disclosure, when multiple messages occur on multiple narrowbands of a system bandwidth, a UE that supports receiving on only one narrowband of a full bandwidth needs to receive one of the multiple messages according to a preset priority.

It is to be noted that the above “UE that supports receiving on only one narrowband of a full bandwidth” may be a UE that has a receiving capability of only one narrowband, e.g., when the system bandwidth is 20 MHz, the UE has a receiving capability of 1.4 MHz; or the UE is capable of receiving information on the full bandwidth but has limited receiving capability; or when the system bandwidth is not a regular bandwidth of 1.4 MHz, 3 MHz, 5 MHz, 10 MHz, 15 MHz or 20 MHz in an existing protocol, but an irregular bandwidth, such as 8 MHz, then the UE can only choose an regular bandwidth in 1.4 MHz, 3 MHz and 5 MHz to receive downlink information; or when multiple messages occur on a same narrowband of the system bandwidth, the UE that supports receiving on only one narrowband of the full bandwidth and can only process one message needs to receive one of the multiple messages according to a preset priority.

Additionally, it is to be noted that embodiments of the present disclosure are also applicable to a scenario where the UE has a receiving capability of a full bandwidth but is capable of receiving only one of the multiple messages in one subframe. Practical applications are not limited to the above scenario.

As can be seen from the above, embodiments of the present disclosure are not limited to application in transmission of an MTC UE, and further include, but are not limited to, application in a UE that has a receiving capability less than the system bandwidth or a UE whose receiving bandwidth is limited.

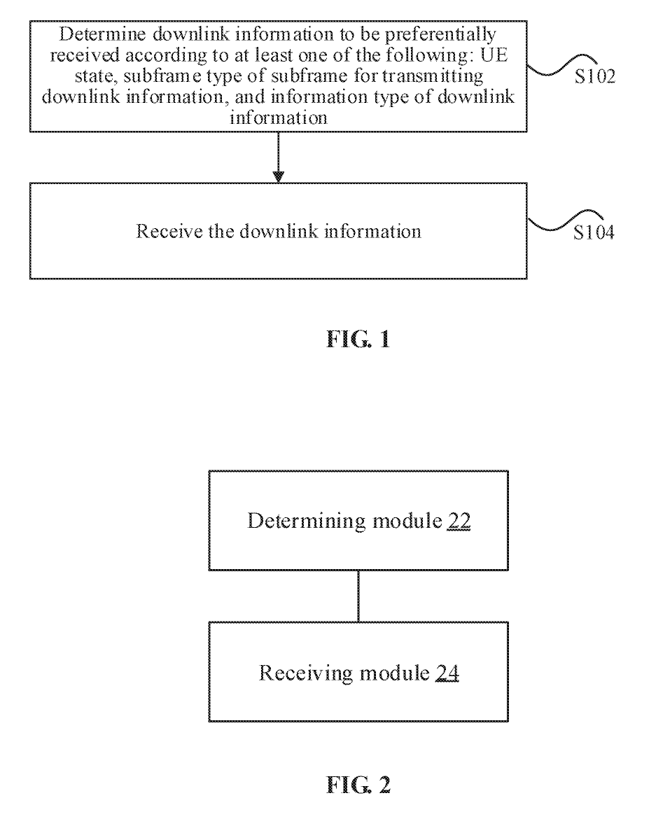

To achieve the above object, an embodiment of the present disclosure provides a method for receiving downlink information. FIG. 1 is a flowchart of the method for receiving downlink information according to the embodiment of the present disclosure. As illustrated in FIG. 1, the method includes the following steps.

In step S102, the downlink information to be preferentially received is determined according to at least one of: UE state, subframe type of a subframe for transmitting downlink information, and information type of downlink information;

In step S104, the downlink information is received.

In the above steps, the downlink information to be preferentially received is determined among multiple pieces of downlink information to be received and then the determined downlink information to be preferentially received is received. This solves a low efficiency problem when a UE receives multiple pieces of downlink information on one narrowband, and thus improves the efficiency of the UE in receiving downlink information.

Preferably, the UE state includes at least one of: during a random access procedure, in an RRC idle state, in an RRC connected state, in a system message change period and in an MCCH change period. Depending on the different states of the UE, the downlink information to be preferentially received may be determined in each UE state separately.

Preferably, the subframe type includes: MBSFN subframe or non-MBSFN subframe.

Preferably, the information type of the downlink information includes at least two of: downlink control channel for scheduling an RAR and/or RAR; downlink control channel for scheduling a message 4 during the random access procedure and/or message 4; downlink control channel for scheduling a paging message and/or paging message; downlink control channel for scheduling a system message and/or system message; downlink control channel for scheduling the UE to send a PUSCH; downlink control channel for scheduling the UE to send a PDSCH and/or PDSCH of the UE; PDSCH for SPS; downlink control channel for scheduling a retransmitted PDSCH and/or retransmitted PDSCH; MCCH change notification information; and PMCH. That is, when the UE needs to receive two or more pieces of the various types of information mentioned above, it may be determined according to a preset rule that certain piece of downlink information is preferentially received, so as to improve the efficiency in receiving downlink information.

Preferably, the downlink control channel includes one of: PDCCH and EPDCCH. The downlink control channel in the embodiment of the present disclosure may also be a newly defined downlink control channel carrying downlink control information.

Preferably, the MCCH change notification information and the PMCH further include at least one of the following cases: the MCCH change notification information and/or information of a narrowband where the PMCH locates are/is notified by an eNB in a SIB or an MCCH; information of a narrowband where the MCCH locates is notified by the eNB in the SIB; and information of a narrowband carrying an MBMS in the PMCH is notified by the eNB in the SIB or the MCCH.

Preferably, the method further includes: notifying, by an MCE, the eNB of the MCCH change notification information and/or the information of a narrowband where the PMCH and/or the MCCH locates and/or the information of a narrowband carrying the MBMS in the PMCH.

In the present disclosure, the MCCH change notification information and the PMCH are each sent on a narrowband with a bandwidth less than a system bandwidth, the MCCH change notification information and/or information of a narrowband where the PMCH locates are/is notified by an eNB in a SIB or an MCCH; information of a narrowband where the MCCH locates is notified by the eNB in the SIB; and information of a narrowband carrying an MBMS in the PMCH is notified by the eNB in the SIB or the MCCH. Moreover, the MCE notifies the eNB of the MCCH change notification information and/or the information of a narrowband where the PMCH and/or the MCCH locates and/or the information of a narrowband carrying the MBMS in the PMCH. The following illustrates examples in which the UE determines the downlink information to be preferentially received according to the UE state, the subframe type of the subframe for transmitting the downlink information, and the information type of the downlink information.

Preferably, in step S104, the UE preferentially detects the downlink control channel for scheduling the RAR and/or receives the RAR when the UE is in an RAR time window during the random access procedure and before the UE receives the RAR.

Preferably, in step S104, the UE preferentially detects the downlink control channel for scheduling the message 4 and/or receives the message 4 when the UE is in a subframe for detecting the downlink control channel for scheduling the message 4 and/or receiving the message 4 during the random access procedure.

Preferably, in step S104, the UE preferentially detects the downlink control channel for scheduling the paging message and/or receives the paging message when the UE is in the RRC idle state and in a subframe for detecting the downlink control channel for scheduling the paging message and/or receiving the paging message, where the subframe for detecting the downlink control channel for scheduling the paging message and/or receiving the paging message includes: the MBSFN subframe or the non-MBSFN subframe.

Preferably, in step S104, the UE preferentially detects the downlink control channel for scheduling the paging message and/or receives the paging message when the UE is in the RRC connected state, in a system message change period and in a designated subframe for detecting the downlink control channel for scheduling the paging message and/or receiving the paging message, where the designated subframe for detecting the downlink control channel for scheduling the paging message and/or receiving the paging message includes: the MBSFN subframe or the non-MBSFN subframe.

Preferably, in step S104, the designated subframe for detecting the downlink control channel for scheduling the paging message and/or receiving the paging message includes: a first preset subframe in the system message change period, and a subframe for detecting the downlink control channel for scheduling the paging message and/or receiving the paging message after the first preset subframe and before the paging message is received.

Preferably, the first preset subframe includes one of the following features: a number of subframes between a starting subframe of the system message change period and the first preset subframe is a preset value; a number of subframes between the first preset subframe and an ending subframe of the system message change period is a preset value; a number of opportunities for receiving the paging message between the starting subframe of the system message change period and the first preset subframe is a preset value; and a number of opportunities for receiving the paging message between the first preset subframe and the ending subframe of the system message change period is a preset value.

Preferably, in step S104, the UE preferentially detects the downlink control channel for scheduling the system message and/or receives the system message in the system message change period after the UE receives a system message change notification and in a subframe for detecting the downlink control channel for scheduling the system message and/or receiving the system message before the UE correctly receives the system message, where the subframe for detecting the downlink control channel for scheduling the system message and/or receiving the system message includes: the MBSFN subframe or the non-MBSFN subframe.

Preferably, in step S104, the UE preferentially detects the downlink control channel for scheduling the system message and/or receives the system message in a preset time when the UE does not receive the system message change notification and in the subframe for detecting the downlink control channel for scheduling the system message and/or receiving the system message before the UE correctly receives the system message, where the subframe for detecting the downlink control channel for scheduling the system message and/or receiving the system message includes: the MBSFN subframe or the non-MBSFN subframe.

Preferably, in step S104, the UE preferentially receives the PDSCH in an overlapping subframe when a time window in which the UE receives the PDSCH overlaps a designated time window and when an initial position of the time window in which the UE receives the PDSCH is earlier than or equal to an initial position of the designated time window; or preferentially receives the PDSCH in an overlapping subframe when a time window in which the UE detects the downlink control channel for scheduling the retransmitted PDSCH and/or receives the retransmitted PDSCH overlaps a designated time window and when an initial position of the time window in which the UE detects the downlink control channel for scheduling the retransmitted PDSCH and/or receives the retransmitted PDSCH is earlier than or equal to an initial position of the designated time window.

Preferably, the designated time window includes one of: RAR time window in which the UE receives the RAR; time window in which the UE detects the downlink control channel for scheduling the paging message and/or receives the paging message; time window in which the UE detects the downlink control channel for scheduling the system message and/or receives the system message; time window in which the UE receives the PMCH; and time window in which the UE detects the MCCH change notification information.

Preferably, in step S104, the UE preferentially receives the PMCH in a designated MBSFN subframe when the UE supports the MBMS.

Preferably, in step S104, the UE preferentially detects the MCCH change notification information in the designated MBSFN subframe in the MCCH change period.

Preferably, the designated MBSFN subframe includes: a second preset subframe in the MCCH change period, and a subframe for receiving the MCCH change notification information after the second preset subframe and before the UE detects the MCCH change notification.

Preferably, the second preset subframe includes one of the following features: a number of subframes between the starting subframe of the MCCH change period and the second preset subframe is a preset value; a number of subframes between the second preset subframe and an ending subframe of the MCCH change period is a preset value; a number of opportunities for receiving the MCCH change notification information between the starting subframe of the MCCH change period and the second preset subframe is a preset value; and a number of opportunities for receiving the MCCH change notification information between the second preset subframe and the ending subframe of the MCCH change period is a preset value.

Another embodiment of the present disclosure provides a device for receiving downlink information, which is configured to implement the above-mentioned examples and preferred embodiments. What has been described will not be repeated. Modules involved in the device will be described below. As used below, the term “module” enables a combination of software and/or hardware of preset functions. The device described in the following embodiment is preferably implemented by software, but implementation by software or by a combination of software and hardware is also possible and conceived.

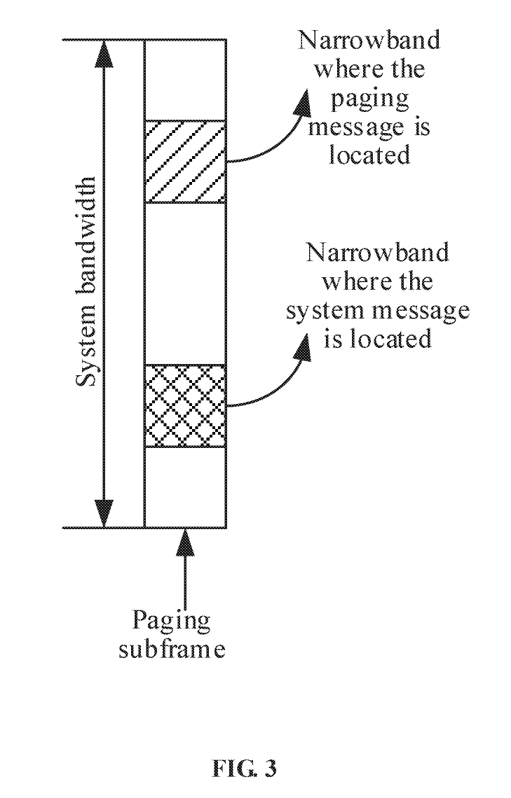

FIG. 2 is a schematic structural diagram of the device for receiving downlink information according to the embodiment of the present disclosure. As illustrated in FIG. 2, the device includes: a determining module 22 and a receiving module 24. The determining module 22 is configured to determine the downlink information to be preferentially received according to at least one of: UE state, subframe type of a subframe for transmitting downlink information, and information type of downlink information. The receiving module 24 is coupled to the determining module 22 and is configured to receive the downlink information.

Through the combined effect of the above modules, a low efficiency problem is solved when a UE receives multiple pieces of downlink information on one narrowband, and thus the efficiency of the UE in receiving downlink information is improved.

Preferably, the UE state includes at least one of: during a random access procedure, in an RRC idle state, in an RRC connected state, in a system message change period and in an MCCH change period.

Preferably, the subframe type includes: MBSFN subframe or non-MBSFN subframe.

Preferably, the information type includes at least two of: downlink control channel for scheduling an RAR and/or RAR; downlink control channel for scheduling a message 4 during the random access procedure and/or message 4; downlink control channel for scheduling a paging message and/or paging message; downlink control channel for scheduling a system message and/or system message; downlink control channel for scheduling the UE to send a PUSCH; downlink control channel for scheduling the UE to send a PDSCH and/or PDSCH of the UE; PDSCH for SPS; downlink control channel for scheduling a retransmitted PDSCH and/or retransmitted PDSCH; MCCH change notification information; and PMCH.

Preferably, the downlink control channel includes one of: PDCCH and EPDCCH.

Preferably, the MCCH change notification information and the PMCH further include at least one of the following cases: the MCCH change notification information and/or information of a narrowband where the PMCH locates are/is notified by an eNB in a SIB or an MCCH; information of a narrowband where the MCCH locates is notified by the eNB in the SIB; and information of a narrowband carrying an MBMS in the PMCH is notified by the eNB in the SIB or the MCCH.

Preferably, the receiving module 24 is configured to preferentially detect the downlink control channel for scheduling the RAR and/or receive the RAR when the UE is in an RAR time window during the random access procedure and before the UE receives the RAR.

Preferably, the receiving module 24 is configured to detect the downlink control channel for scheduling the message 4 and/or receive the message 4 when the UE is in a subframe for detecting the downlink control channel for scheduling the message 4 and/or receiving the message 4 during the random access procedure.

Preferably, the receiving module 24 is configured to preferentially detect the downlink control channel for scheduling the paging message and/or receive the paging message when the UE is in the RRC idle state and in a subframe for detecting the downlink control channel for scheduling the paging message and/or receiving the paging message, where the subframe for detecting the downlink control channel for scheduling the paging message and/or receiving the paging message includes: the MBSFN subframe or the non-MBSFN subframe.

Preferably, the receiving module 24 is configured to preferentially detect the downlink control channel for scheduling the paging message and/or receive the paging message when the UE is in the RRC connected state, in a system message change period and in a designated subframe for detecting the downlink control channel for scheduling the paging message and/or receiving the paging message, where the designated subframe for detecting the downlink control channel for scheduling the paging message and/or receiving the paging message includes: the MBSFN subframe or the non-MBSFN subframe.

Preferably, the designated subframe for detecting the downlink control channel for scheduling the paging message and/or receiving the paging message includes: a first preset subframe in the system message change period, and a subframe for detecting the downlink control channel for scheduling the paging message and/or receiving the paging message after the first preset subframe and before the paging message is received.

Preferably, the first preset subframe includes one of the following features: a number of subframes between a starting subframe of the system message change period and the first preset subframe is a preset value; a number of subframes between the first preset subframe and an ending subframe of the system message change period is a preset value; a number of opportunities for receiving the paging message between the starting subframe of the system message change period and the first preset subframe is a preset value; and a number of opportunities for receiving the paging message between the first preset subframe and the ending subframe of the system message change period is a preset value.

Preferably, the receiving module 24 is configured to preferentially detect the downlink control channel for scheduling the system message and/or receive the system message in the system message change period after the UE receives a system message change notification and in a subframe for detecting the downlink control channel for scheduling the system message and/or receiving the system message before the UE correctly receives the system message, where the subframe for detecting the downlink control channel for scheduling the system message and/or receiving the system message includes: the MBSFN subframe or the non-MBSFN subframe.

Preferably, the receiving module 24 is configured to preferentially detect the downlink control channel for scheduling the system message and/or receive the system message in a preset time when the UE does not receive the system message change notification and in the subframe for detecting the downlink control channel for scheduling the system message and/or receiving the system message before the UE correctly receives the system message, where the subframe for detecting the downlink control channel for scheduling the system message and/or receiving the system message includes: the MBSFN subframe or the non-MBSFN subframe.

Preferably, the receiving module 24 is configured to preferentially receive the PDSCH in an overlapping subframe when a time window in which the UE receives the PDSCH overlaps a designated time window and when an initial position of the time window in which the UE receives the PDSCH is earlier than or equal to an initial position of the designated time window; or preferentially receive the PDSCH in an overlapping subframe when a time window in which the UE detects the downlink control channel for scheduling the retransmitted PDSCH and/or receives the retransmitted PDSCH overlaps a designated time window and when an initial position of the time window in which the UE detects the downlink control channel for scheduling the retransmitted PDSCH and/or receives the retransmitted PDSCH is earlier than or equal to an initial position of the designated time window.

Preferably, the designated time window includes one of: RAR time window in which the UE receives the RAR; time window in which the UE detects the downlink control channel for scheduling the paging message and/or receives the paging message; time window in which the UE detects the downlink control channel for scheduling the system message and/or receives the system message; time window in which the UE receives the PMCH; and time window in which the UE detects the MCCH change notification information.

Preferably, the receiving module 24 is configured to preferentially receive the PMCH in a designated MBSFN subframe when the UE supports the MBMS.

Preferably, the receiving module 24 is configured to preferentially detect the MCCH change notification information in the designated MBSFN subframe in the MCCH change period.

Preferably, the designated MBSFN subframe includes: a second preset subframe in the MCCH change period, and a subframe for receiving the MCCH change notification information after the second preset subframe and before the UE detects the MCCH change notification.

Preferably, the second preset subframe includes one of the following features: a number of subframes between the starting subframe of the MCCH change period and the second preset subframe is a preset value; a number of subframes between the second preset subframe and an ending subframe of the MCCH change period is a preset value; a number of opportunities for receiving the MCCH change notification information between the starting subframe of the MCCH change period and the second preset subframe is a preset value; and a number of opportunities for receiving the MCCH change notification information between the second preset subframe and the ending subframe of the MCCH change period is a preset value.

Another embodiment of the present disclosure provides a UE, including: the above device for receiving downlink information.

Additionally, various function units in embodiments of the present disclosure may be integrated into one processing unit, or each unit may be physically present separately, or two or more units may be integrated into one unit. The integrated unit may be implemented by hardware or a software function unit.

To make clearer the description of embodiments of the present disclosure, the following description will be made with reference to preferred embodiments.

### Preferred Embodiment I

When a UE is in an RRC idle state, public messages that need to be received include a paging message and a system message. The two messages and/or control information for scheduling the two messages may be in the same subframe.

If the paging message and the system message are both blindly transferred, i.e., are not scheduled by a downlink control channel, and are on different narrowbands, then, if the system message is sent in a subframe for sending the paging message and no system message change notification is received before this subframe, the UE preferentially receives the paging message, because the paging message may contain information about the UE being paged or system message update, etc. As illustrated in FIG. 3, the two messages are on different narrowbands in the subframe where the paging message is located, and the UE modulates the frequency to a narrowband where the paging message is located, i.e., a narrowband with oblique lines, to receive the paging message.

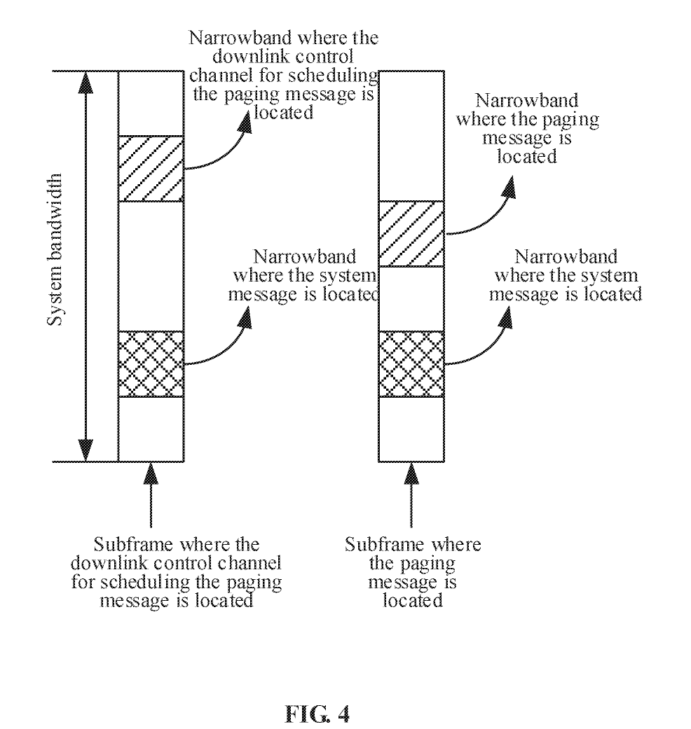

If one of the paging message and the system message is blindly transferred and the other is scheduled by the downlink control channel, then, if the system message is sent in the downlink control channel for scheduling the paging message and a subframe where the paging message is located, or if a scheduling system message and the system message are sent in the subframe where the paging message is located, and no system message change notification is received before this subframe, the UE preferentially detects the downlink control channel for scheduling the paging message and receives the paging message. As illustrated in FIG. 4, in the downlink control channel for scheduling the paging message and the subframe where the paging message is located, the UE modulates the frequency to a narrowband where the downlink control channel for scheduling the paging message and the paging message are located to receive the downlink control channel for scheduling the paging message and the paging message. The narrowband where the downlink control channel for scheduling the paging message and the paging message are located is a narrowband where a common search space (CSS) for scheduling the paging message is located, i.e., the narrowband with oblique lines. If some subframes are between the downlink control channel for scheduling the paging message and the paging message, e.g., the downlink control channel for scheduling the paging message is repeated for several times with an ending subframe of n, and a starting subframe of the paging message is n+k, where k>0, e.g., k=4, then, if the system message is sent in k−1 subframes of subframe n+1, n+2, . . . , n+k−1, the UE compares k with a threshold K. If k≥K, the UE receives the system message; otherwise, the UE does not receive the system message. K is a preset value, a value set by an eNB, or the number of times the system message is repeated.

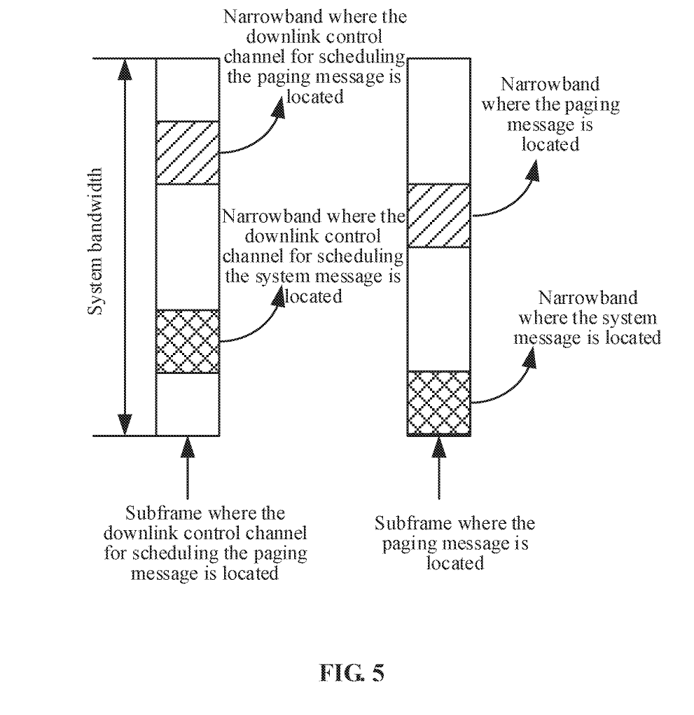

If the paging message and the system message are both scheduled by the downlink control channel, then, if the downlink control channel for scheduling the system message and/or the system message are/is sent in the downlink control channel for scheduling the paging message and the subframe where the paging message is located and no system message change notification is received before this subframe, the UE preferentially detects the downlink control channel for scheduling the paging message and receives the paging message. As illustrated in FIG. 5, in the downlink control channel for scheduling the paging message and the subframe where the paging message is located, the UE modulates the frequency to a narrowband where the downlink control channel for scheduling the paging message and the paging message are located to receive the downlink control channel for scheduling the paging message and the paging message. The narrowband where the downlink control channel for scheduling the paging message and the paging message are located is the narrowband where the CSS for scheduling the paging message is located, i.e., the narrowband with oblique lines. If some subframes are between the downlink control channel for scheduling the paging message and the paging message, e.g., the downlink control channel for scheduling the paging message is repeated for several times with an ending subframe of n, and the starting subframe of the paging message is n+k, where k>0, e.g., k=4, then, if the system message and/or the downlink control channel for scheduling the system message are/is sent in k−1 subframes of subframe n+1, n+2, . . . , n+k−1, the UE compares k with a threshold K. If k≥K, the UE receives the system message; otherwise, the UE does not receive the system message. K is a preset value, a value set by the eNB, or the number of times the system message and/or the downlink control channel for scheduling the system message are/is repeated.

Moreover, in addition to the downlink control channel for scheduling the system message and/or the system message, a PMCH change notification information and/or an MCCH change notification information may also be sent in a subframe for detecting the downlink control channel for scheduling the paging message and/or receiving the paging message in an MBSFN subframe. At this point, the UE still preferentially detects the downlink control channel for scheduling the paging message and/or the paging message.

### Preferred Embodiment II

During a random access procedure, a UE first sends a preamble and then receives an RAR in a time window. This time window is referred to as an RAR time window. An eNB sends the RAR corresponding to the UE and/or a downlink control channel for scheduling the RAR in one or more subframes selected by the eNB from this time window. The size of the time window is set by the eNB or is preset. In the RAR time window, the content that the eNB may send to the UE may further include at least one of a downlink control channel for scheduling a system message and/or the system message; a downlink control channel for scheduling a paging message and/or the paging message; a downlink control channel for scheduling the UE to send a PUSCH; and a downlink control channel for scheduling the UE to receive a PDSCH and/or the PDSCH of the UE. The random access here includes both competitive random access and noncompetitive random access. In addition to the above messages, the content sent by the eNB to the UE in an MBSFN subframe may further include a PMCH change notification information and/or an MCCH change notification information.

In the RAR time window in which the UE receives the RAR, the UE preferentially receives the RAR before correctly receiving the RAR.

If the RAR is blindly transferred, the UE preferentially receives the RAR on a narrowband where the RAR is located. If the RAR is transferred by the downlink control channel, the UE preferentially detects the downlink control channel for scheduling the RAR and/or receives the RAR on a narrowband where the downlink control channel for scheduling the RAR and/or the RAR are/is located.

If some subframes are between the downlink control channel for scheduling the RAR and the RAR, e.g., the downlink control channel for scheduling the RAR is repeated for several times with an ending subframe of n, and the starting subframe of the RAR is n+k, where k>0, e.g., k=4, then, if the above other messages and/or the downlink control channel for scheduling the above other messages are/is sent in k−1 subframes of subframe n+1, n+2, . . . , n+k−1, the UE compares k with a threshold K. If k≥K, the UE receives the above other messages and/or detects the downlink control channel for scheduling the above other messages; otherwise, the UE does not receive the above other messages or detect the downlink control channel for scheduling the above other messages. K is a preset value, a value set by the eNB, or the number of times the above other messages and/or the downlink control channel for scheduling the above other messages are/is repeated.

Moreover, during a random access procedure, when the UE receives the RAR, sends a message 3 and then receives a message 4 sent by the eNB, the UE preferentially detects a downlink control channel for scheduling the message 4 and/or receives the message 4 in a subframe for detecting the downlink control channel for scheduling the message 4 and/or receiving the message 4.

### Preferred Embodiment III

When a UE is in a connected state, the UE still needs to receive a paging message to obtain information such as whether a system message is changed or not. A UE supporting an Earthquake and Tsunami Warning System (ETWS) and a Commercial Mobile Alert Service (CMAS) also needs to receive paging messages to obtain information about whether alarms are reported by the ETWS and the CMAS. If the UE detects a system message change, the UE will re-receive the system message in next system message change period.

In a subframe where the paging message is located, the content that an eNB may send to the UE may further include at least one of a downlink control channel for scheduling a system message and/or the system message; a downlink control channel for scheduling a paging message and/or the paging message; a downlink control channel for scheduling the UE to send a PUSCH; a downlink control channel for scheduling the UE to receive a PDSCH and/or the PDSCH of the UE; and a downlink control channel for scheduling an RAR and/or the RAR. In addition to the above messages, the content sent by the eNB to the UE in an MBSFN subframe may further include a PMCH change notification information and/or an MCCH change notification information.

In the present embodiment, a threshold is defined. In a subframe for detecting the downlink control channel for scheduling the paging message and/or receiving the paging message after this threshold (including this threshold) in the system message change period, the UE preferentially receives the paging message before receiving the paging message.

If the paging message is blindly transferred, the UE preferentially receives the paging message on the narrowband where the paging message is located in the subframe where the paging message is located. If the paging message is transferred by the downlink control channel, in a subframe where the paging message and the downlink control channel for scheduling the paging message are located, the UE preferentially detects the downlink control channel for scheduling the paging message and/or receives the paging message on a narrowband where the downlink control channel for scheduling the paging message and the paging message are located.

For example, if the system message change period is 256 radio frames and the threshold is 200 radio frames, then, in the subframe where the paging message and/or the downlink control channel for scheduling the paging message are/is located after (or defined as before) the 200 radio frames (including the 200th radio frame) in the system message change period, the UE preferentially receives the paging message and/or detects the downlink control channel for scheduling the paging message before receiving the paging message.

Alternatively, the threshold may also be defined as the number of the remaining opportunities for receiving the paging message in the system message change period, where the number of opportunities for receiving the paging message may be the number of subframes for receiving the paging message, or when the paging message is repeatedly sent, e.g., repeated sent for 10 times, then the repeated 10 times of paging message may be regarded as one opportunity for receiving the paging message. The threshold may be the above N or a preset value. For example, if the threshold is 4, then, if 4 opportunities remain for receiving the paging message in the system message change period, the UE preferentially receives the paging message and/or detects the downlink control channel for scheduling the paging message before receiving the paging message.

If some subframes are between the downlink control channel for scheduling the paging message and the paging message, e.g., the downlink control channel for scheduling the paging message is repeated for several times with an ending subframe of n, and a starting subframe of the paging message is n+k, where k>0, e.g., k=4, then, if other messages and/or the downlink control channel for scheduling the other messages are/is sent in k−1 subframes of subframe n+1, n+2, . . . , n+k−1, the UE compares k with a threshold K. If k≥K, the UE receives the other messages and/or detects the downlink control channel for scheduling the other messages; otherwise, the UE does not receive the other messages or detect the downlink control channel for scheduling the other messages. K is a preset value, a value set by the eNB, or the number of times the other messages and/or the downlink control channel for scheduling the other messages are/is repeated.

### Preferred Embodiment IV

When a UE receives a system message change information contained in a paging message in a system message change period, the UE preferentially receives a system message in next system message change period before normally receiving the system message. That is, in a subframe where a downlink control channel for scheduling the system message and/or the system message are/is located in the system message change period, the UE preferentially receives the system message rather than other information. The content that an eNB may send to the UE may further include at least one of a downlink control channel for scheduling an RAR and/or the RAR; a downlink control channel for scheduling a paging message and/or the paging message; a downlink control channel for scheduling the UE to send a PUSCH; and a downlink control channel for scheduling the UE to receive a PDSCH and/or the PDSCH of the UE.

Alternatively, when the UE does not receive a system message change notification in a preset time, the UE preferentially receives the system message. For example, if the preset time is 5 hours and if 5 hours have passed, then, in the subframe where the downlink control channel for scheduling the system message and/or the system message are/is located after 5 hours, if the downlink control channel for scheduling the RAR and/or the RAR need/needs to be received, the UE preferentially receives the RAR; otherwise, the UE preferentially receives the system message rather than other information.

If some subframes are between the downlink control channel for scheduling the system message and the system message, e.g., the downlink control channel for scheduling the system message is repeated for several times with an ending subframe of n, and a starting subframe of the system message is n+k, where k>0, e.g., k=4, then, if the above other messages and/or the downlink control channel for scheduling the above other messages are/is sent in k−1 subframes of subframe n+1, n+2, . . . , n+k−1, the UE compares k with a threshold K. If k≥K, the UE receives the above other messages and/or detects the downlink control channel for scheduling the above other messages; otherwise, the UE does not receive the above other messages or detect the downlink control channel for scheduling the above other messages. K is a preset value, a value set by the eNB, or the number of times the above other messages and/or the downlink control channel for scheduling the above other messages are/is repeated.

### Preferred Embodiment V

A UE preferentially receives a PDSCH in an overlapping subframe if a time window in which the UE receives a PDSCH or a time window in which the UE detects a downlink control channel for scheduling a retransmitted PDSCH and/or receives the retransmitted PDSCH overlaps a designated time window and if an initial position of the time window in which the UE receives the PDSCH or the time window in which the UE detects the downlink control channel for scheduling the retransmitted PDSCH and/or receives the retransmitted PDSCH is earlier than or equal to an initial position of the designated time window. The time window in which the UE receives the PDSCH may be a time window in which a UE scheduled by a downlink control channel of the UE receives the PDSCH. For example, if an eNB schedules the UE to receive 10 repeated PDSCHs in subsequent 10 subframes, the time window in which the UE receives the PDSCH is these 10 subframes. Alternatively, the time window in which the UE receives the PDSCH is a time window in which the UE correctly receives the PDSCH. For example, if the eNB schedules the UE to receive 10 repeated PDSCHs in subsequent 10 subframes but the UE correctly receives the PDSCH after receiving 6 subframes, the time window in which the UE receives the PDSCH is these 6 subframes. The time window in which the UE detects the downlink control channel for scheduling the retransmitted PDSCH and/or receives the retransmitted PDSCH is defined in a way similar to the time window in which the UE receives the PDSCH.

The designated time window refers to an RAR time window in which the UE receives an RAR. The definition of the RAR time window is described in the preferred embodiment II. Alternatively, the designated time window refers to a time window in which the UE detects a downlink control channel for scheduling a paging message and/or receives the paging message. The time window in which the UE detects the downlink control channel for scheduling the paging message and/or receives the paging message refers to a time window for receiving the paging message, which is set by the eNB or preset and is similar to the RAR time window. The time window in which the UE detects the downlink control channel for scheduling the paging message and/or receives the paging message may also refer to a subframe in which the eNB sends the paging message for once. For example, if the eNB sends the downlink control channel for scheduling the paging message and the paging message in one subframe, the time window in which the UE detects the downlink control channel for scheduling the paging message and/or receives the paging message refers to this subframe. The eNB may also send the paging message repeatedly. For example, if the downlink control channel for scheduling the paging message and the paging message occupy a total of 20 subframes, these 20 subframes are the time window in which the UE receives the paging message. Alternatively, the designated time window refers to a time window in which the UE detects a downlink control channel for scheduling a system message and/or receives the system message. Such definition of the time window is similar to the definition of the time window for receiving the paging message. Alternatively, the designated time window refers to a time window in which the UE receives a PMCH or a time window in which the UE detects an MCCH change notification information. For example, if the PMCH is sent in one MBSFN subframe, the time window refers to one subframe.

As illustrated in FIG. 6, the UE preferentially receives the PDSCH in an overlapped subframe if the time window in which the UE receives the PDSCH overlaps the RAR time window and an initial position of the time window for the PDSCH is earlier than the RAR time window.

### Preferred Embodiment VI

In a case where a system bandwidth is greater than a receiving bandwidth of a UE, PMCH and MCCH change notification information is sent on one or more narrowbands of the system bandwidth. In an MBSFN subframe, in addition to PMCH and MCCH change notification information, the content that an eNB may send to the UE may further include at least one of a downlink control channel for scheduling a system message and/or the system message; a downlink control channel for scheduling a paging message and/or the paging message; a downlink control channel for scheduling an RAR and/or the RAR; a downlink control channel for scheduling the UE to send a PUSCH; and a downlink control channel for scheduling the UE to receive a PDSCH and/or the PDSCH of the UE.

The PMCH sent to the UE by the eNB may be important information, e.g., alarm information or upgrade information sent to an MTC UE. In this case, the UE preferentially receives the PMCH in a designated MBSFN subframe. The designated MBSFN subframe is an MBSFN subframe in which the UE needs to receive the PMCH sent by the eNB. The designated MBSFN subframe is a subset of MBSFN subframes of a cell.

The eNB may send the MCCH change information to the UE in some MBSFN subframes. The MCCH change information may be sent for multiple times in an MCCH change period. The MCCH change information is used for indicating whether an MCCH is changed. If the MCCH has been changed, the UE needs to receive the MCCH change information in next MCCH change period. The UE preferentially receives the MCCH change notification information in the designated MBSFN subframe in the MCCH change period.

The designated MBSFN subframe refers to a subframe for receiving the MCCH change notification information after a preset subframe (including the preset subframe) and before the UE the MCCH change notification information in the MCCH change period.

A number of subframes between a starting subframe of the MCCH change period and the preset subframe is a preset value; a number of subframes between the preset subframe and an ending subframe of the MCCH change period is a preset value; a number of opportunities for receiving the MCCH change notification information between the preset subframe and the ending subframe of the MCCH change period is a preset value; or a number of opportunities for receiving the MCCH change notification information between the starting subframe of the MCCH change period and the preset subframe is a preset value.

### Preferred Embodiment VII

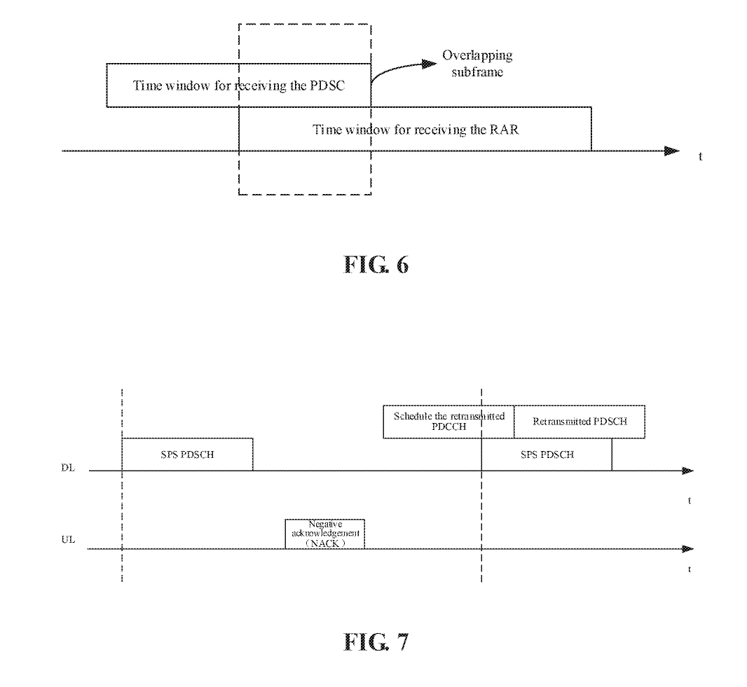

When an eNB activates SPS downlink retransmission to a UE, the eNB sends a PDSCH to the UE according to a configured period. This is referred to as a PDSCH for SPS in the present disclosure. The UE preferentially receives and detects a downlink control channel for scheduling a retransmitted message and/or receives the retransmitted message when a time window in which the UE receives the PDSCH for SPS overlaps a time window in which the UE detects the downlink control channel for scheduling the retransmitted message and/or receives the retransmitted message and an initial position of the time window in which the UE detects the downlink control channel for scheduling the retransmitted message and/or receives the retransmitted message is equal to or earlier than the time window in which the UE receives the PDSCH for SPS. See FIG. 7.

In conclusion, since the MTC UE has a small receiving bandwidth, the UE can only choose to receive information on one narrowband if multiple pieces of information, such as the RAR, the paging message, the system message, the downlink data, etc., are sent on different narrowbands of one subframe. In the case of coverage enhancement, the system may be inefficient if the UE makes an improper choice. Through the above examples and preferred embodiments of the present disclosure, the present disclosure defines the reception priority of the UE in different scenarios and improves the system efficiency.

Another embodiment provides a software for implementing the solutions described in the above-mentioned examples and preferred embodiments.

Another embodiment provides a storage medium, which stores the above-mentioned software and includes but is not limited to an optical disk, a floppy disk, a hard disk and a rewritable memory.

It is to be noted that the terms “first”, “second” and the like in the specification, claims and accompanying drawings of the present disclosure are used to distinguish similar objects and are not necessarily used to describe a particular order or sequence. It is to be understood that the objects used in this way are interchangeable where appropriate so that embodiments of the present disclosure described herein may also be implemented in a sequence not illustrated or described herein. In addition, the terms “comprising”, “including” or any other variations thereof described herein are intended to encompass a non-exclusive inclusion. For example, a process, method, system, product or device that includes a series of steps or elements not only includes the expressly listed steps or elements but may also include other steps or elements that are not expressly listed or are inherent to such process, method, system, product or device.

Apparently, those skilled in the art should know that each above-mentioned module or step of the present disclosure may be implemented by a universal computing device, they may be concentrated on a single computing device or distributed on a network formed by a plurality of computing devices, and alternatively, they may be implemented by program codes executable by the computing devices, so that they may be stored in a storage device for execution by the computing devices, and in some circumstances, the illustrated or described steps may be executed in sequences different from those described here, or they may be made into various integrated circuit modules separately, or multiple modules or steps therein may be made into a single integrated circuit module for implementation. Therefore, the present disclosure is not limited to any specific combination of hardware and software.

The above are only preferred embodiments of the present disclosure and are not intended to limit the present disclosure, and for those skilled in the art, the present disclosure may have various modifications and variations. Any modifications, equivalent substitutions, improvements and the like within the spirit and principle of the present disclosure are within the scope of the present disclosure.

### INDUSTRIAL APPLICABILITY

The above solutions provided by embodiments of the present disclosure are applicable to a process of receiving downlink information. In these solutions, the downlink information to be preferentially received is determined according to at least one of: UE state, subframe type of a subframe for transmitting downlink information, and information type of downlink information; and the downlink information is then received. This solves the low efficiency problem when the UE receives multiple pieces of downlink information on one narrowband, and thus improves the efficiency of the UE in receiving downlink information.

1. A method for receiving downlink information, comprising:
determining downlink information to be preferentially received according to at least one of: user equipment (UE) state, subframe type of a subframe for transmitting downlink information, or information type of downlink information; and
receiving the downlink information,
wherein the method is performed by at least one processor.

2. The method according to claim 1, wherein the UE state comprises at least one of:
during a random access procedure, in a radio resource control (RRC), idle state, in an RRC connected state, in a system message change period and in a Multicast Control Channel (MCCH) or change period.

3. The method according to claim 1, wherein the subframe type comprises: Multimedia Broadcast Multicast Service Single Frequency Network (MBSFN) subframe or non-MBSFN subframe.

4. The method according to claim 1, wherein the information type comprises at least two of:
downlink control channel for scheduling a Random Access Response (RAR) and/or the RAR;
downlink control channel for scheduling a message 4 during the random access procedure and/or the message 4;
downlink control channel for scheduling a paging message and/or the paging message;
downlink control channel for scheduling a system message and/or the system message;
downlink control channel for scheduling the UE to send a Physical Uplink Shared Channel (PUSCH);
downlink control channel for scheduling the UE to send a Physical Downlink Shared Channel (PDSCH), and/or the PDSCH of the UE;
PDSCH for Semi-Persistent Scheduling (SPS);
downlink control channel for scheduling a retransmitted PDSCH and/or the retransmitted PDSCH;
MCCH change notification information; or
Physical Multicast Channel (PMCH).

5. The method according to claim 4, wherein the downlink control channel comprises at least one of:
Physical Downlink Control Channel (PDCCH), or Enhanced Physical Downlink Control Channel (EPDCCH).

6. The method according to claim 4, wherein the MCCH change notification information and the PMCH further comprise at least one of:
the MCCH change notification information and/or information of a narrowband where the PMCH is located are/is notified by an eNB in a system information block (SIB), or an MCCH;
information of a narrowband where the MCCH locates is notified by the eNB in the SIB; or
information of a narrowband carrying a Multimedia Broadcast Multicast Service (MBMS), in the PMCH is notified by the eNB in the SIB or the MCCH.

7. The method according to claim 6, further comprising:
notifying, by a Multicell/Multicast Coordination Entity (MCE), the eNB of the MCCH change notification information and/or the information of a narrowband where the PMCH and/or the MCCH are located and/or the information of a narrowband carrying the MBMS in the PMCH.

8. The method according to claim 1, wherein receiving the downlink information comprises:
preferentially detecting a downlink control channel for scheduling an RAR and/or receiving the RAR in response to determining that a UE is in an RAR time window during a random access procedure and before the UE receives the RAR.

9. The method according to claim 1, wherein receiving the downlink information comprises:
preferentially detecting a downlink control channel for scheduling a message 4 and/or receiving the message 4 in response to determining that a UE is in a subframe for detecting the downlink control channel for scheduling the message 4 and/or receiving the message 4 during a random access procedure.

10. The method according to claim 1, wherein receiving the downlink information comprises:
preferentially detecting a downlink control channel for scheduling a paging message and/or receiving the paging message in response to determining that a UE is in an RRC idle state and in a subframe for detecting the downlink control channel for scheduling the paging message and/or receiving the paging message,
wherein the subframe for detecting the downlink control channel for scheduling the paging message and/or receiving the paging message comprises: MBSFN subframe or non-MBSFN subframe.

11. The method according to claim 1, wherein receiving the downlink information comprises:
preferentially detecting a downlink control channel for scheduling a paging message and/or receiving the paging message in response to determining that a UE is in an RRC connected state, in a system message change period and in a designated subframe for detecting the downlink control channel for scheduling the paging message and/or receiving the paging message,
wherein the designated subframe for detecting the downlink control channel for scheduling the paging message and/or receiving the paging message comprises: MBSFN subframe or non-MBSFN subframe;
wherein the designated subframe for detecting the downlink control channel for scheduling the paging message and/or receiving the paging message comprises:
a first preset subframe in the system message change period, and a subframe for detecting the downlink control channel for scheduling the paging message and/or receiving the paging message after the first preset subframe and before the paging message is received.

12. (canceled)

13. The method according to claim 11, wherein the first preset subframe comprises at least one of:
a number of subframes between a starting subframe of the system message change period and the first preset subframe is a preset value;
a number of subframes between the first preset subframe and an ending subframe of the system message change period is a preset value;
a number of opportunities for receiving the paging message between the starting subframe of the system message change period and the first preset subframe is a preset value; or
a number of opportunities for receiving the paging message between the first preset subframe and the ending subframe of the system message change period is a preset value.

14. The method according to claim 1, wherein receiving the downlink information comprises:
preferentially detecting a downlink control channel for scheduling a system message and/or receiving the system message in a system message change period after a UE receives a system message change notification and in a subframe for detecting the downlink control channel for scheduling the system message and/or receiving the system message before the UE correctly receives the system message,
wherein the subframe for detecting the downlink control channel for scheduling the system message and/or receiving the system message comprises: MBSFN subframe or non-MBSFN subframe.

15. The method according to claim 1, wherein receiving the downlink information comprises:
preferentially detecting a downlink control channel for scheduling a system message and/or receiving the system message in a preset time in response to determining that a UE does not receive a system message change notification and in a subframe for detecting the downlink control channel for scheduling the system message and/or receiving the system message before the UE correctly receives the system message,
wherein the subframe for detecting the downlink control channel for scheduling the system message and/or receiving the system message comprises: MBSFN subframe or non-MBSFN subframe.

16. The method according to claim 1, wherein receiving the downlink information comprises:
preferentially receiving a PDSCH in an overlapping subframe in response to determining that a time window in which a UE receives the PDSCH overlaps a designated time window and in response to determining that an initial position of the time window in which the UE receives the PDSCH is earlier than or equal to an initial position of the designated time window; or
preferentially receiving a PDSCH in an overlapping subframe in response to determining that a time window in which a UE detects a downlink control channel for scheduling a retransmitted PDSCH and/or receives the retransmitted PDSCH overlaps a designated time window and in response to determining that an initial position of the time window in which the UE detects the downlink control channel for scheduling the retransmitted PDSCH and/or receives the retransmitted PDSCH is earlier than or equal to an initial position of the designated time window.

17. The method according to claim 16, wherein the designated time window comprises at least one of:
RAR time window in which the UE receives an RAR;
time window in which the UE detects a downlink control channel for scheduling a paging message and/or receives the paging message;
time window in which the UE detects a downlink control channel for scheduling a system message and/or receives the system message;
time window in which the UE receives a PMCH; or
time window in which the UE detects an MCCH change notification information.

18. The method according to claim 1, wherein receiving the downlink information comprises:
preferentially receiving a PMCH in a designated MBSFN subframe in response to determining that a UE supports an MBMS.

19. The method according to claim 1, wherein receiving the downlink information comprises:
preferentially detecting an MCCH change notification information in a designated MBSFN subframe in an MCCH change period;
wherein the designated MBSFN subframe comprises:
a second preset subframe in the MCCH change period, and a subframe for receiving the MCCH change notification information after the second preset subframe and before the UE detects the MCCH change notification.

20. (canceled)

21. The method according to claim 19, wherein the second preset subframe comprises at least one of:
a number of subframes between a starting subframe of the MCCH change period and the second preset subframe is a preset value;
a number of subframes between the second preset subframe and an ending subframe of the MCCH change period is a preset value;
a number of opportunities for receiving the MCCH change notification information between the starting subframe of the MCCH change period and the second preset subframe is a preset value;
a number of opportunities for receiving the MCCH change notification information between the second preset subframe and the ending subframe of the MCCH change period is a preset value.

22-42. (canceled)

43. A non-transitory computer-readable storage medium storing executable instructions that, when executed by an electronic device, cause the electronic device to perform the following method:
determining downlink information to be preferentially received according to at least one of: UE state, subframe type of a subframe for transmitting downlink information, and information type of downlink information; and
receiving the downlink information.
